(19) United States
(12) Patent Application Publication
(10) Pub. No.: US 2025/0326625 A1
(43) Pub. Date: Oct. 23, 2025

(54) METHOD OF OPERATING A DISPENSING ASSEMBLY OF A REFRIGERATOR APPLIANCE

(71) Applicant: Haier US Appliance Solutions, Inc., Wilmington, DE (US)

(72) Inventor: Tomas Garces, Louisville, KY (US)

(21) Appl. No.: 18/638,316

(22) Filed: Apr. 17, 2024

(51) Int. Cl. B67D 1/08; A47J 43/044; B67D 1/00; B67D 1/12; F25D 23/12

(52) U.S. Cl. CPC B67D 1/0888; A47J 43/044; B67D 1/0014; B67D 1/1234; F25D 23/126; A47J 2043/04454

(57) ABSTRACT

A refrigerator appliance includes a chilled chamber defined within a cabinet, a door providing selective access to the chilled chamber, the door defining a dispenser recess, and a dispensing assembly mounted to the door for selectively providing water through the dispenser recess. A controller is in operative communication with the dispensing assembly and an external network and is configured to obtain a target volume of water from the external network, detect a presence of a container within the dispenser recess, and dispense the target volume of water into the container using the dispensing assembly.

### FIELD OF THE INVENTION

The present subject matter relates generally to refrigerator appliances, and more particularly to methods of operating a dispensing assembly of a refrigerator appliance in conjunction with a stand mixer.

### BACKGROUND OF THE INVENTION

Stand mixers are commonly used in residential and commercial kitchens for performing mixing, churning, or kneading involved in food preparation. Typically, stand mixers include a motor configured to provide torque to one or more driveshafts. Users may connect various utensils to the one or more driveshafts, including whisks, spatulas, or the like. Operating a stand mixer is frequently a manual process, which involves the user attending to multiple activities when baking or cooking, and often have dirty/messy hands, e.g., due to contacting ingredients such as flour, eggs, milk, etc. It is undesirable for a user to operate the stand mixer or other appliances with dirty/messy hands or for a user to repeatedly wash their hands while performing a recipe using the stand mixer.

Conventional kitchens also include refrigerator appliances or other water dispensing devices. For example, refrigerator appliances generally include a cabinet that defines a chilled chamber and one or more doors rotatably hinged to the cabinet. A dispensing assembly may be mounted to the door for selectively dispensing water. However, a user that needs water for a recipe being performed with a nearby stand mixer must often interact manually with the dispensing assembly to get water needed to perform a mixing recipe. Accordingly, conventional mixing processes require repeated hand washing or result in dirty and contaminated appliances.

Accordingly, methods of operating kitchen appliances in an improved manner with a stand mixer would be useful. More particularly, a stand mixer that may communicate with appliances for improved mixing and cooking processes would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a refrigerator appliance is provided including a chilled chamber defined within a cabinet, a door providing selective access to the chilled chamber, the door defining a dispenser recess, a dispensing assembly mounted to the door for selectively providing water through the dispenser recess, and a controller in operative communication with the dispensing assembly and an external network. The controller is configured to obtain a target volume of water from the external network, detect a presence of a container within the dispenser recess, and dispense the target volume of water into the container using the dispensing assembly.

In another exemplary embodiment, a method of operating a dispensing assembly of a refrigerator appliance is provided. The refrigerator appliance is in operative communication with an external network and the method includes obtaining a target volume of water from the external network, detecting a presence of a container within a dispenser recess, and dispensing the target volume of water into the container using the dispensing assembly.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to an example embodiment of the present subject matter.

FIG. 2 provides a perspective view of the exemplary refrigerator appliance of FIG. 1, with the doors of the fresh food chamber shown in an open position.

FIG. 3 provides a side view of an example stand mixer with a bowl according to example embodiments of the present disclosure.

FIG. 4 provides a method of operating a refrigerator appliance and a stand mixer according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

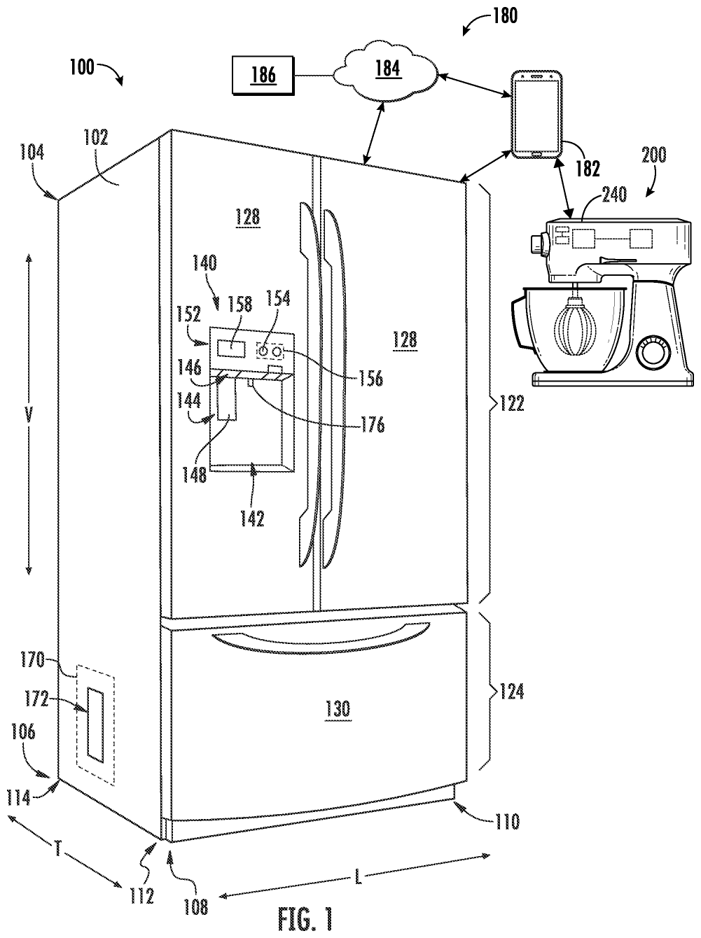

FIG. 1 illustrates a perspective view of a refrigerator appliance 100 according to an exemplary embodiment of the present subject matter. Refrigerator appliance 100 includes a housing or cabinet 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another and form an orthogonal direction system.

Cabinet 102 defines chilled chambers for receipt of food items for storage. In particular, cabinet 102 defines fresh food chamber 122 positioned at or adjacent top 104 of cabinet 102 and a freezer chamber 124 arranged at or adjacent bottom 106 of cabinet 102. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance, a side-by-side style refrigerator appliance, or a single door refrigerator appliance. Moreover, aspects of the present subject matter may be applied to other appliances as well, such as other appliances including fluid dispensers. Consequently, the description set forth herein is for illustrative purposes only and is not intended to be limiting in any aspect to any particular appliance or configuration.

Refrigerator doors 128 are rotatably hinged to an edge of cabinet 102 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. To prevent leakage of cool air, refrigerator doors 128, freezer door 130, and/or cabinet 102 may define one or more sealing mechanisms (e.g., rubber gaskets, not shown) at the interface where the doors 128, 130 meet cabinet 102. It should be appreciated that doors having a different style, position, or configuration are possible within the scope of the present subject matter.

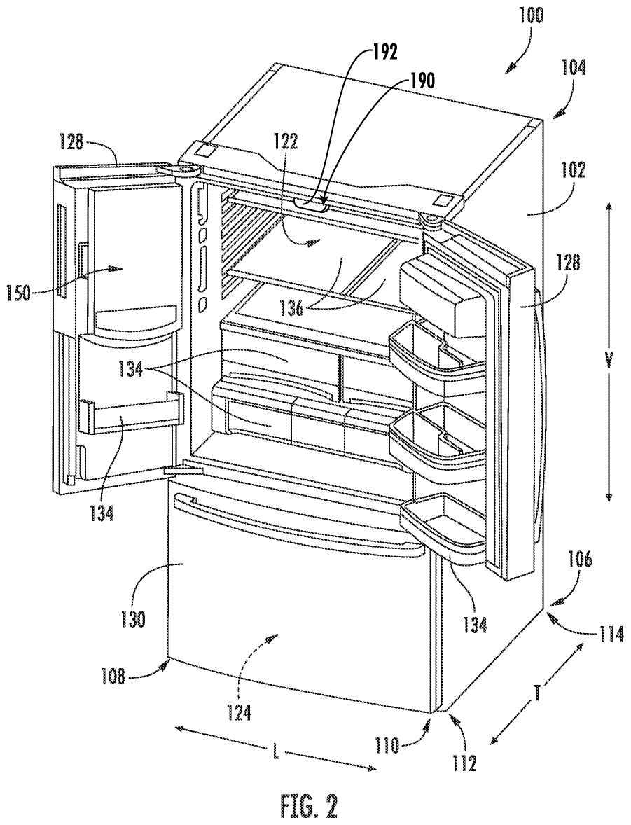

FIG. 2 provides a perspective view of refrigerator appliance 100 shown with refrigerator doors 128 in the open position. As shown in FIG. 2, various storage components are mounted within fresh food chamber 122 to facilitate storage of food items therein as will be understood by those skilled in the art. In particular, the storage components may include bins 134 and shelves 136. Each of these storage components are configured for receipt of food items (e.g., beverages and/or solid food items) and may assist with organizing such food items. As illustrated, bins 134 may be mounted on refrigerator doors 128 or may slide into a receiving space in fresh food chamber 122. It should be appreciated that the illustrated storage components are used only for the purpose of explanation and that other storage components may be used and may have different sizes, shapes, and configurations.

Referring again to FIG. 1, a dispensing assembly 140 will be described according to exemplary embodiments of the present subject matter. Although several different exemplary embodiments of dispensing assembly 140 will be illustrated and described, similar reference numerals may be used to refer to similar components and features. Dispensing assembly 140 is generally configured for dispensing liquid water and/or ice. Although an exemplary dispensing assembly 140 is illustrated and described herein, it should be appreciated that variations and modifications may be made to dispensing assembly 140 while remaining within the present subject matter.

Dispensing assembly 140 and its various components may be positioned at least in part within a dispenser recess 142 defined on one of refrigerator doors 128. In this regard, dispenser recess 142 is defined on a front side 112 of refrigerator appliance 100 such that a user may operate dispensing assembly 140 without opening refrigerator door 128. In addition, dispenser recess 142 is positioned at a predetermined elevation convenient for a user to access ice and enabling the user to access ice without the need to bend-over. In the exemplary embodiment, dispenser recess 142 is positioned at a level that approximates the chest level of a user.

Dispensing assembly 140 includes an ice dispenser 144 including a discharging outlet 146 for discharging ice or water from dispensing assembly 140. An actuating mechanism 148, shown as a paddle, is mounted below discharging outlet 146 for operating ice or water dispenser 144. In alternative exemplary embodiments, any suitable actuating mechanism may be used to operate ice dispenser 144. For example, ice dispenser 144 can include a sensor (such as an ultrasonic sensor) or a button rather than the paddle. Discharging outlet 146 and actuating mechanism 148 are an external part of ice dispenser 144 and are mounted in dispenser recess 142. By contrast, refrigerator door 128 may define an icebox compartment 150 (FIG. 2) housing an icemaker and an ice storage bin (not shown) that are configured to supply ice to dispenser recess 142.

According to an example embodiment, dispensing assembly 140 may include an auto-dispense feature for metering water and/or ice dispensing. In this regard, for example, dispensing assembly 140 may further include a flow meter (not shown) or other suitable device for monitoring the flow rate or volume of water being dispensed from dispensing assembly 140. For example, the flow meter may be a paddlewheel flow meter, a positive displacement flow meter, an electromagnetic flow meter, an ultrasonic flow meter, or any other suitable device for measuring the flow rate. Upon receiving a command to dispense a target volume of water and detecting the presence of a container for receiving the water, dispensing assembly 140 may automatically actuate to dispense the target volume of water into the container.

A control panel 152 is provided for controlling the mode of operation. For example, control panel 152 includes one or more selector inputs 154, such as knobs, buttons, touchscreen interfaces, etc., such as a water dispensing button and an ice-dispensing button, for selecting a desired mode of operation such as crushed or non-crushed ice. In addition, inputs 154 may be used to specify a fill volume or method of operating dispensing assembly 140. In this regard, inputs 154 may be in communication with a processing device or controller 156. Signals generated in controller 156 operate refrigerator appliance 100 and dispensing assembly 140 in response to selector inputs 154. Additionally, a display 158, such as an indicator light or a screen, may be provided on control panel 152. Display 158 may be in communication with controller 156, and may display information in response to signals from controller 156.

As used herein, “processing device” or “controller” may refer to one or more microprocessors or semiconductor devices and is not restricted necessarily to a single element. The processing device can be programmed to operate refrigerator appliance 100, dispensing assembly 140 and other components of refrigerator appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

Referring again briefly to FIG. 1, according to an exemplary embodiment, cabinet 102 also defines a mechanical compartment 170 at or near the bottom 106 of the cabinet 102 for receipt of a hermetically sealed cooling system 172. In general, sealed cooling system 172 is configured for transporting heat from the inside of refrigerator appliance 100 to the outside (e.g., by executing a vapor-compression cycle or another suitable refrigeration cycle). As is generally understood by those of skill in the art, the hermetically sealed system 172 contains a working fluid, e.g., refrigerant, which flows between various heat exchangers of the sealed system 172 where the working fluid changes phases while transferring thermal energy.

In this regard, as understood by one having ordinary skill in the art, sealed system 172 may include a compressor, a condenser, an expansion device, and one or more evaporators connected in series by a fluid conduit that is charged with a refrigerant. Within sealed system 172, refrigerant flows into the compressor, which operates to increase the pressure of the refrigerant. This compression of the refrigerant raises its temperature, which is lowered by passing the refrigerant through the condenser. Within the condenser, heat exchange with ambient air takes place so as to cool the refrigerant. A condenser fan may be used to pull air across the condenser, so as to provide forced convection for a more rapid and efficient heat exchange between the refrigerant within the condenser and the ambient air. Thus, as will be understood by those skilled in the art, increasing air flow across the condenser can, e.g., increase the efficiency of the condenser by improving cooling of the refrigerant contained therein.

An expansion device (e.g., an electronic expansion valve, capillary tube, or other restriction device) receives refrigerant from the condenser. From the expansion device, the refrigerant enters the evaporator. Upon exiting the expansion device and entering the evaporator, the refrigerant drops in pressure. Due to the pressure drop and/or phase change of the refrigerant, the evaporator is relatively cool. An evaporator fan is typically provided at each the evaporator, e.g., to force air across and around the at least one evaporator to transfer thermal energy from the air to the evaporator (and more particularly, to the working fluid or refrigerant therein).

In this manner, a flow of cooling air exits the evaporator and may be distributed to one or more of the chilled chambers 122 and/or 124. Specifically, one or more ducts may extend between the mechanical compartment 170 and the chilled chambers 122 and/or 124 to provide fluid communication therebetween, e.g., to provide the chilled air from the hermetically sealed cooling system 172, e.g., from an evaporator thereof, to one or more of the chilled chambers 122 and/or 124.

The sealed system 172 described herein is provided by way of example only. Thus, it is within the scope of the present subject matter for other configurations of the refrigeration system to be used as well. For example, according to alternative embodiments, sealed system 172 may include additional components, e.g., at least one additional evaporator, compressor, expansion device, and/or condenser. For example, refrigerator appliance 100 may have two or more split evaporators, e.g., one dedicated primarily to cooling fresh food chamber 122 and one dedicated primarily to cooling freezer chamber 124. In addition, alternative plumbing configurations, valves, and flow regulators may be used to route refrigerant throughout sealed system 172.

In some embodiments, refrigerator appliance 100 also includes one or more sensors that may be used to facilitate improved operation of refrigerator appliance 100, such as described below. For example, in order to obtain temperature measurements within one or more chilled chambers 122, 124 (or regions/zones within chilled chambers 122, 124), refrigerator appliance 100 may include a plurality of temperature sensors (not shown). Controller 156 may be communicatively coupled with the temperature sensors, may receive signals from these temperature sensors that correspond to the temperature of an atmosphere or air within their respective locations, and may implement responsive action, e.g., by directing more or less cooling air toward that region or chamber.

As used herein, “temperature sensor” or the equivalent is intended to refer to any suitable type of temperature measuring system or device positioned at any suitable location for measuring the desired temperature. Thus, for example, the temperature sensors may be any suitable type of temperature sensor, such as a thermistor, a thermocouple, a resistance temperature detector, etc. In addition, the temperature sensors may be positioned at any suitable location and may output a signal, such as a voltage, to a controller that is proportional to and/or indicative of the temperature of the air surrounding the temperature sensors. Although exemplary positioning of temperature sensors is described and illustrated herein, it should be appreciated that refrigerator appliance 100 may include any other suitable number, type, and position of temperature and/or other sensors according to alternative embodiments.

According to example embodiments of the present subject matter, dispensing assembly 140 may further include a container sensing assembly 176 that is positioned within dispenser recess 142 for facilitating the performance of an auto-dispense cycle of dispensing assembly 140. In this regard, for example, container sensing assembly 176 may be configured to detect the presence (or absence) of a container within dispenser recess 142 (e.g., underneath discharging outlet 146). As explained in more detail below, controller 156 may be in operative communication with container sensing assembly 176 and may be configured for confirming the presence of a container prior to initiating an auto-dispense cycle.

According to example embodiments, container sensing assembly 176 may include any suitable number or type of sensors for determining the presence of a container for receiving ice and/or water. For example, container sensing assembly 176 may include at least one of a time-of-flight sensor, an infrared sensor, an optical sensor, a proximity sensor, a weight sensor, a non-contact scanning device, etc. According to an example embodiment, container sensing assembly 176 may include a light detection and ranging (LiDAR) sensor. In general, a LiDAR system may include an emitter and a receiver and may generally be configured to map the container and liquids contained therein. In this regard, the emitter may be the source of any form of energy which may be measured or detected by the receiver, e.g., for detecting the presence, location, geometry, and/or orientation of the container.

Referring still to FIG. 1, a schematic diagram of an external communication system 180 will be described according to an exemplary embodiment of the present subject matter. In general, external communication system 180 is configured for permitting interaction, data transfer, and other communications between refrigerator appliance 100 and one or more external devices. For example, this communication may be used to provide and receive operating parameters, user instructions or notifications, performance characteristics, user preferences, or any other suitable information for improved performance of refrigerator appliance 100. In addition, it should be appreciated that external communication system 180 may be used to transfer data or other information to improve performance of one or more external devices or appliances and/or improve user interaction with such devices.

For example, external communication system 180 permits controller 156 of refrigerator appliance 100 to communicate with a separate device external to refrigerator appliance 100, referred to generally herein as an external device 182. As described in more detail below, these communications may be facilitated using a wired or wireless connection, such as via a network 184. In general, external device 182 may be any suitable device separate from refrigerator appliance 100 that is configured to provide and/or receive communications, information, data, or commands from a user. In this regard, external device 182 may be, for example, a personal phone, a smartphone, a tablet, a laptop or personal computer, a wearable device, a smart home system, or another mobile or remote device.

In addition, a remote server 186 may be in communication with refrigerator appliance 100 and/or external device 182 through network 184. In this regard, for example, remote server 186 may be a cloud-based server 186, and is thus located at a distant location, such as in a separate state, country, etc. According to an exemplary embodiment, external device 182 may communicate with a remote server 186 over network 184, such as the Internet, to transmit/receive data or information, provide user inputs, receive user notifications or instructions, interact with or control refrigerator appliance 100, etc. In addition, external device 182 and remote server 186 may communicate with refrigerator appliance 100 to communicate similar information.

In general, communication between refrigerator appliance 100, external device 182, remote server 186, and/or other user devices or appliances may be carried using any type of wired or wireless connection and using any suitable type of communication network, non-limiting examples of which are provided below. For example, external device 182 may be in direct or indirect communication with refrigerator appliance 100 through any suitable wired or wireless communication connections or interfaces, such as network 184. For example, network 184 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 180 is described herein according to an exemplary embodiment of the present subject matter. However, it should be appreciated that the exemplary functions and configurations of external communication system 180 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

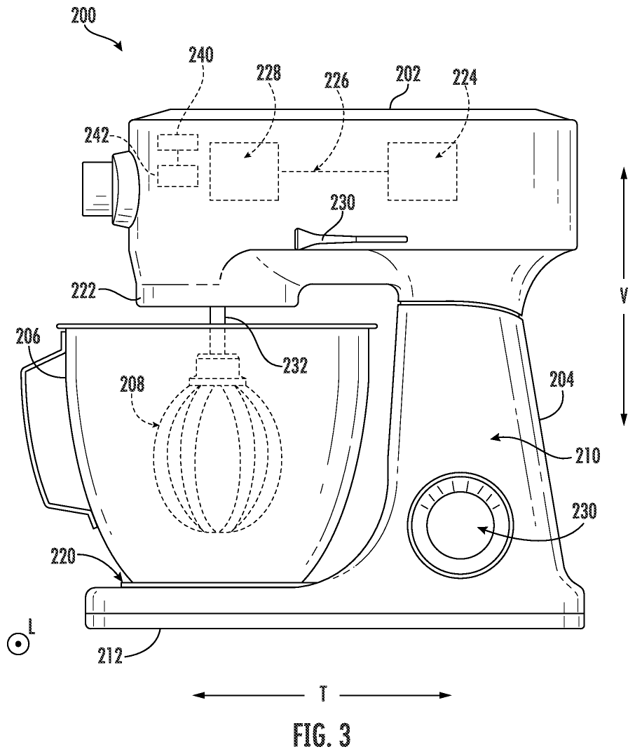

Referring again to FIG. 1, a stand mixer 200 will be described according to an example embodiment of the present subject matter. Specifically, as illustrated, stand mixer appliance 200 may be in operative communication with refrigerator appliance 200, external device 182, and remote server 186, e.g., through network 184. In this manner, stand mixer 200 may interact with a user, cloud-based mixing recipes, and the refrigerator appliance 100 to facilitate improved operation, as described in more detail below. With reference now to FIG. 3, stand mixer 200 includes a housing 202 and a base 204. Stand mixer 200 may extend between housing 202 and base 204 in a vertical direction V, across housing 202 in a lateral direction L, and from a front to a back in a transverse direction T. The vertical direction V, lateral direction L, and transverse direction T are perpendicular to one another.

Housing 202 may be pivotally mounted to base 204 and extends transversely between the front and the back of stand mixer appliance 200 when in the mixing position shown in FIG. 3. In some embodiments, housing 202 may be non-pivotably attached to base 204. Other configurations may be used where housing 202 may allow for access to a bowl 206 or to a removable mixing attachment 208, as otherwise understood. Various types of attachments 208 may be used including e.g., whisks, paddles, dough hooks, beaters, and others for purposes of mixing articles or mechanically manipulating articles within bowl 206 or other containers supported by base 204.

For this embodiment, base 204 includes upright support 210 and a horizontal base member 212. As shown, upright support 210 extends vertically from horizontal base member 212 and horizontal base member 212 extends transversely in front of upright support 210. Horizontal base member 212 may include a scale 220. In some embodiments, scale 220 may be concave, grooved, or otherwise shaped to accept bowl 206. Scale 220 may be generally configured to weigh bowl 206 and the contents therein.

Housing 202 includes an attachment support 222. A motor 224 is disposed within the housing 202. Attachment support 222 is located on a lower portion or underside of housing 202 and forward of upright support 210 along transverse direction T. A mixing shaft 232 extends from attachment support 222. Removable mixing attachment 208 removably attaches to shaft 232. A drivetrain 226 connects motor 224 with one or more gears 228 for causing rotation of attachment 208 or mixing shaft 232, e.g., mixing shaft 232 may be operably coupled to motor 224. Gears 228 may allow for selection by the user of different rotating speeds for attachment 208. In general, mixing attachment 208 may be coupled to shaft 232 prior to rotation of shaft 232 by motor 224.

During use, attachment support 222 with mixing shaft 232 may rotate attachment 208 in a circular or planetary fashion. Spinning in a planetary fashion, as used herein, includes spinning an object (e.g., shaft 232) about a first axis and revolving the object around a second axis, the object offset from the second axis. For example, shaft 232 may spin about a shaft axis, and revolve around a central axis, shaft 232 offset from central axis to generate spinning in a planetary rotation. The shaft axis may also be offset from the central axis. In some embodiments, motor 224 may be disposed within base 204, including within upright support 210.

Stand mixer 200 may include one or more controls 230 for operations such as selectively powering motor 224, choosing the speed of rotation for attachments 208, locking position of housing 202 relative to base 204 during mixing, or other features. In some embodiments, controls 230 may include a rotational direction operation selection, allowing a user to select the direction of rotation of the mixing shaft 232. In addition, stand mixer 200 may include a controller 240. In particular, controller 240 may be located within housing 202 and may be configured for operating stand mixer 200, communicating with network 184, etc. Controller 240 may be the same or similar to controller 156 described above, and further detail regarding the controller 240 is omitted here for brevity.

In general, stand mixer 200 may include a sensor, such as an accelerometer 242, in data communication with controller 240. In general, controller 240 may be configured to receive tap data from accelerometer 242, determine a command based upon the tap data from accelerometer 242, and operate stand mixer 200 in response to the determined command. Moreover, accelerometer 242 may be configured to determine changes in vibrations of housing 202 by comparing a measured vibration at housing 202 to a threshold vibration value, e.g., determining the changes in vibration may include determining the measured vibration at housing 202 surpasses the threshold vibration value. In some additional or alternative embodiments, the sensor may be a capacitive touch sensor. In general, the capacitive touch sensor may detect changes in capacitance at housing 202, such that a change in capacitance at the housing corresponds to a user contact with housing 202 or a command to perform a specific action.

As may be seen from the above, the stand mixer may be tapped to be operated. In general, controller 240 may determine a command based upon the tap data from accelerometer 242. A user may therefore be able to tap the stand mixer with knuckles, wrist, or forearm to perform multiple operations. A sensor, such as an accelerometer, may pick up minute vibrations which can be converted to different actions/operations, e.g., to advance a mixing recipe. Other sensors can be used such as capacitive sensors. Additionally, the user may customize the desired functions of the stand mixer through an external device.

Now that the construction and configuration of refrigerator appliance 100, stand mixer 200, and external network 180 have been presented according to an exemplary embodiment of the present subject matter, an exemplary method 300 for operating a refrigerator appliance in conjunction with a stand mixer is provided. Method 300 can be used to operate refrigerator appliance 100 or to operate any other refrigerator. In this regard, for example, controller 156 may be configured for implementing method 300. However, it should be appreciated that the example method 300 is discussed herein only to describe exemplary aspects of the present subject matter and is not intended to be limiting.

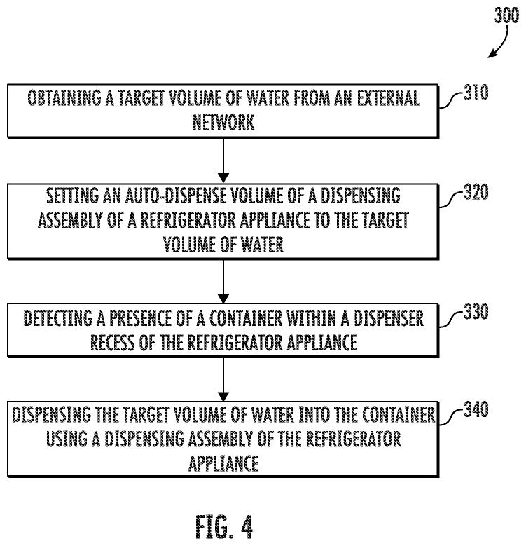

As shown in FIG. 4, method 300 includes, at step 310, obtaining a target volume of water from an external network. In this regard, continuing the example from above, refrigerator appliance 100 may generally be in communication with external device 182, remote server 186, or other external appliances (e.g., such as stand mixer 200) through network 184 and external communication system 180. Controller 156 of refrigerator appliance 100 may obtain or determine the target volume of water through communication with the external network 184. According to example embodiments of the present subject matter, this target volume of water may be associated with a recipe being used with stand mixer 200. According to still other embodiments, the target volume of water may be obtained from any other suitable residential or commercial appliance that requires a specific volume of water for a specific task and is in operative communication with refrigerator appliance 100.

In general, the communication providing the target volume of water may be initiated and/or transmitted from and/or through any suitable device connected to network 184. For example, external device 182 (e.g., such as a user's mobile phone) may be implementing a software application in conjunction with performance of a mixing recipe using stand mixer 200. A software application on external device 182 may determine that the mixing recipe calls for a step where a predetermined amount or target volume of water is needed to be added into bowl 206 of stand mixer 200. Accordingly, in order to reduce or eliminate direct user contact with refrigerator appliance (e.g., and thereby preventing transfer of food or filth from a user's hands), external device 182 and/or stand mixer 200 may communicate the target volume of water to refrigerator appliance 100.

More specifically, for example, the target volume may be communicated when the software application on external device 182 determines that the next mixing step requires the target volume of water. By contrast, the target volume of water may be communicated to refrigerator appliance 100 upon receiving a user input (e.g., via stand mixer 200 or external device 182). For example, the target volume of water may be communicated when a button is pressed on a user interface of stand mixer 200. In addition, or alternatively, the target volume of water may be communicated when a sensor (e.g., such as accelerometer 242) senses that a user has tapped stand mixer 200 (e.g., indicating that the current mixing step is complete and the next step should be initiated). Alternatively, a user may manually advance to the next step through a software application on external device 182 and this manual advancement may initiate communication of the target volume of water.

Notably, once the refrigerator appliance 100 has received the target volume of water, controller 156 of refrigerator appliance 100 may automatically set an auto-dispense volume to the target volume of water, e.g., at step 320. In this regard, the auto-dispense volume is the amount of water that dispensing assembly 140 will dispense next time dispensing assembly 140 is activated. This target volume may be stored in memory until the dispensing assembly 140 is activated.

Step 330 may include detecting a presence of a container within a dispenser recess of the refrigerator appliance. In this regard, for example, the auto-dispense feature of refrigerator appliance 100 should not be initiated unless a container is present to collect liquids dispensed from dispensing assembly 140. Accordingly, for example, container sensing assembly 176 may be used to ensure that a container having sufficient volume is present within dispenser recess 142 before activating the dispensing process. Notably, according to still other embodiments, detecting the presence of the container within dispenser recess 142 may simply include determining that the dispenser actuating mechanism (actuating mechanism 148) has been triggered. In this regard, when a user presses a cup against actuating mechanism 148, controller 156 may deduce that a proper container is present.

After the target volume of water has been determined and an appropriately-sized container has been detected, step 340 may include dispensing the target volume of water into the container using a dispensing assembly of the refrigerator appliance. It should be appreciated that refrigerator appliance 100 may include one or more flow meters to regulate the operation of dispensing assembly 140 and to ensure that the target volume of water is dispensed during the next activation cycle. As explained briefly above, a flow meter may be used to determine when the target volume of water has been dispensed. According to still other embodiments, container sensing assembly 176 may monitor the dispensing process and determine when the water level within the container reaches a height associated with the target volume of water. In addition, or alternatively, container sensing assembly 176 may be used to stop the dispensing of water in the event that the target volume of water exceeds the storage volume of the container.

FIG. 4 depicts an exemplary control method having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of the methods are explained using refrigerator appliance 100 and stand mixer 200 as an example, it should be appreciated that these methods may be applied to the operation of any suitable water dispensing appliance and/or mixing assembly.

As explained herein, aspects of the present subject matter are directed to a method to automate water dispensing from a dispensing assembly of a refrigerator appliance or other water dispensing system. For example, a user may utilize a software application on a remote device (e.g., such as a mobile phone) to implement a guided recipe performed by a stand mixer. When a step of the recipe being performed by the stand mixer requires water, the stand mixer or the remote device may communicate the desired volume of water to the refrigerator appliance. A user may then place a container under a dispensing spout and a dispensing assembly may be automatically activated (e.g., without physical user interaction) to dispense the desired volume of water (e.g., using an auto-dispense feature of the refrigerator appliance). The auto-dispense feature could automatically sense the container and the volume dispensed into the container or an actuation mechanism may be triggered by the container and a flow meter may be used to determine the volume dispensed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance comprising:
a chilled chamber defined within a cabinet;
a door providing selective access to the chilled chamber, the door defining a dispenser recess;
a dispensing assembly mounted to the door for selectively providing water through the dispenser recess; and
a controller in operative communication with the dispensing assembly and an external network, the controller being configured to:
obtain a target volume of water from the external network;
detect a presence of a container within the dispenser recess; and
dispense the target volume of water into the container using the dispensing assembly.

2. The refrigerator appliance of claim 1, wherein the refrigerator appliance further comprises a container sensing assembly configured to detect the presence of the container within the dispenser recess.

3. The refrigerator appliance of claim 2, wherein the container sensing assembly comprises at least one of a time of flight sensor, a proximity sensor, or a weight sensor.

4. The refrigerator appliance of claim 1, wherein the refrigerator appliance further comprises an actuation mechanism for triggering the dispensing assembly, wherein the actuation mechanism is configured to detect the presence of the container.

5. The refrigerator appliance of claim 1, wherein the controller is further configured to:
determine that a recipe is being performed that includes a step to add the target volume of water; and
set an auto-dispense volume to the target volume of water.

6. The refrigerator appliance of claim 1, wherein the target volume of water is communicated from a stand mixer or an external device in operative communication with the external network.

7. The refrigerator appliance of claim 6, wherein the target volume of water is communicated when a button is pressed on a user interface of the stand mixer.

8. The refrigerator appliance of claim 6, wherein the target volume of water is communicated when a sensor indicates a user has tapped the stand mixer.

9. The refrigerator appliance of claim 1, wherein the target volume of water is communicated from using a software application on a remote device connected to the external network.

10. The refrigerator appliance of claim 1, wherein the dispensing assembly further comprises:
a flow meter for determining when the target volume of water has been dispensed.

11. The refrigerator appliance of claim 1, wherein the dispensing assembly further comprises:
a container sensing assembly configured to detect when the container is filled with the target volume of water.

12. A method of operating a dispensing assembly of a refrigerator appliance, the refrigerator appliance being in operative communication with an external network, the method comprising
obtaining a target volume of water from the external network;
detecting a presence of a container within a dispenser recess; and
dispensing the target volume of water into the container using the dispensing assembly.

13. The method of claim 12, wherein the refrigerator appliance further comprises a container sensing assembly configured to detect the presence of the container within the dispenser recess.

14. The method of claim 12, wherein the refrigerator appliance further comprises an actuation mechanism for triggering the dispensing assembly, wherein the actuation mechanism is configured to detect the presence of the container.

15. The method of claim 12, further comprising:
determining that a recipe is being performed that includes a step to add the target volume of water; and
setting an auto-dispense volume to the target volume of water.

16. The method of claim 12, wherein the target volume of water is communicated from a stand mixer or an external device in operative communication with the external network.

17. The method of claim 16, wherein the target volume of water is communicated when a button is pressed on a user interface of the stand mixer.

18. The method of claim 16, wherein the target volume of water is communicated when a sensor indicates a user has tapped the stand mixer.

19. The method of claim 12, wherein the target volume of water is communicated from using a software application on a remote device connected to the external network.

20. The method of claim 12, wherein the dispensing assembly further comprises a flow meter, the method comprising:
determining that the target volume of water has been dispensed using the flow meter; and
stopping a flow of water using the dispensing assembly.
